(19) United States
(12) Patent Application Publication
(10) Pub. No.: US 2026/0149042 A1
(43) Pub. Date: May 28, 2026

(54) IONIC LIQUID, ELECTROLYTE FOR SECONDARY BATTERY COMPRISING THE IONIC LIQUID, AND SECONDARY BATTERY COMPRISING THE SAME

(71) Applicants: SK ON CO., LTD., Seoul (KR); SK Innovation Co., Ltd., Seoul (KR)

(72) Inventors: Jeong Hoon YOON, Daejeon (KR); Yu Na SHIM, Daejeon (KR); Hong Won LEE, Daejeon (KR); In Haeng CHO, Daejeon (KR)

(21) Appl. No.: 19/342,682

(22) Filed: Sep. 29, 2025

(30) Foreign Application Priority Data
Nov. 27, 2024 (KR) 10-2024-0172291

(51) Int. Cl. H01M 10/0567

(52) U.S. Cl. CPC H01M 10/0567

(57) ABSTRACT

Provided are an ionic liquid, an electrolyte for a secondary battery comprising the ionic liquid, and a secondary battery comprising the electrolyte. The ionic liquid comprises a cationic compound represented by Chemical Formula 1:

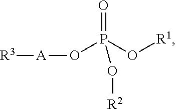

wherein R¹ and R² are independently substituted or unsubstituted C₆ to C₂₀ aryl groups, R³ is an N-containing heterocyclic cation, and A is a C₂ to C₂₀ alkenyl group.

### CROSS-REFERENCE TO RELATED APPLICATION(S)

This patent document claims the priority and benefits of Korean Patent Application No. 10-2024-0172291 filed on Nov. 27, 2024, the disclosure of which is incorporated herein by reference in its entirety.

### TECHNICAL FIELD

The disclosure and implementations disclosed in this patent document generally relate to an ionic liquid, an electrolyte for a secondary battery including the ionic liquid, and a secondary battery including the electrolyte.

### BACKGROUND

With the technological development of, and increasing demand for, mobile devices and electric vehicles, demand for batteries as an energy source has rapidly increased. Consequently, extensive research has been conducted into batteries that may meet these diverse needs.

In particular, demand has been high for lithium secondary batteries, such as lithium-ion batteries and lithium-ion polymer batteries, having superior energy density, discharge voltage, and output stability.

Generally, lithium secondary batteries are manufactured by impregnating an electrode assembly including a positive electrode/separator/negative electrode, made using a lithium transition metal oxide or composite oxide as a positive electrode active material and a carbon-based or silicon-based material as a negative electrode active material, with an electrolyte including a lithium salt.

Meanwhile, lithium secondary batteries using lithium transition metal oxides or composite oxides become thermally unstable when stored at high temperatures in a fully charged state because metal components are released from the positive electrodes thereof. For example, oxygen discharged from the positive electrodes accelerates an exothermic decomposition reaction of an electrolyte solvent, causing batteries to swell, a phenomenon known as swelling, which drastically reduces the lifespan and charge/discharge efficiency of batteries, and in some cases, even leads to battery explosion, significantly degrading battery safety.

Methods of adding flame-retardant compounds, such as ionic liquids, have been proposed to improve the flame-retardant properties of electrolytes. However, while adding ionic liquid-based additives to the electrolyte to secure flame-retardant properties improves thermal stability, side reactions in the graphite, the negative electrode active material, result in a very high initial irreversible capacity and a degradation of the performance of secondary battery cells.

### SUMMARY

The present disclosure may be implemented in some embodiments to provide an electrolyte capable of forming a robust solid electrolyte interphase (SEI) film or positive electrode electrolyte interphase (CEI) film.

The present disclosure may be implemented in some embodiments to improve the thermal stability and high-temperature performance of a battery.

In some embodiments of the present disclosure, an ionic liquid comprises a cationic compound represented by Chemical Formula 1.

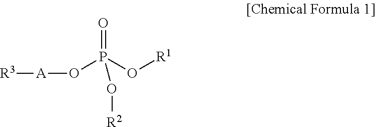

In Chemical Formula 1, R¹ and R² are independently substituted or unsubstituted C₆ to C₂₀ aryl groups, R³ is an N-containing heterocyclic cation, and A is a C₂ to C₂₀ alkenyl group.

The R¹ and R² may independently comprise n substituents X or m substituents Y, X and Y may be independently a C₁ to C₆ alkyl group, a C₁ to C₆ alkoxy group, a halogen group, or a nitrile group, and n and m may be independently integers greater than or equal to 1.

The R³ may be imidazolium, pyridinium, pyridazinium, pyrimidinium, pyrazinium, pyrrolidinium, pyrazolium, thiazolium, oxazolium or triazolium.

The R³ may be represented by Chemical Formula 2.

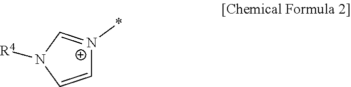

In Chemical Formula 2, R⁴ is a halogen, a substituted or unsubstituted C₁ to C₂₀ alkyl group, a substituted or unsubstituted C₁ to C₂₀ alkoxy group, a substituted or unsubstituted C₁ to C₂₀ vinyl group, or a nitrile group.

The cationic compound may be represented by Chemical Formula 3.

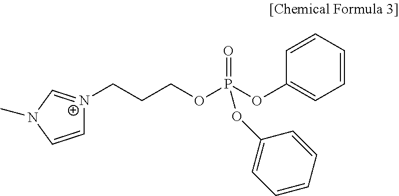 [SMILES: Cn1cc[n+](CCCOP(=O)(Oc2ccccc2)Oc2ccccc2)c1]

The ionic liquid may further comprise at least one anionic compound selected from the group consisting of trifluoromethylsulfonylimide (TFSI), bis(fluorosulfonyl)imide (FSI), trifluoromethanesulfonate (OTf), chloride (Cl), dicyanamide (DCA), acetate (Ac), hydroxide, diethylphosphate (DEP), thiocyanate (SCN), and methylsulfate (MeSO₄).

The ionic liquid may further comprise an anionic compound represented by Chemical Formula 4.

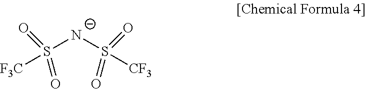 [SMILES: O=S(=O)([N-]S(=O)(=O)C(F)(F)F)C(F)(F)F]

In some embodiments of the present disclosure, an electrolyte comprises the above ionic liquid.

The electrolyte may further comprise a phosphazene compound.

The phosphazene compound may be represented by Chemical Formula 5.

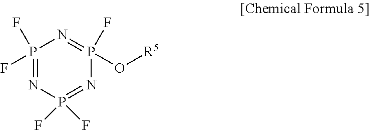

In Chemical Formula 5, R⁵ is a substituted or unsubstituted C₁ to C₂₀ alkyl group, a substituted or unsubstituted C₂ to C₂₀ vinyl group, halogen, or a nitrile group.

In some embodiments of the present disclosure, a secondary battery comprises: a positive electrode, a negative electrode, and an electrolyte, wherein the electrolyte comprises the above ionic liquid.

The electrolyte may further comprise a phosphazene compound.

The phosphazene compound may be represented by Chemical Formula 5.

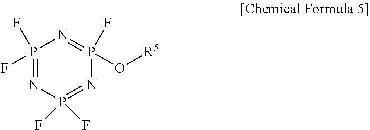

In the chemical formula 5, R⁵ is a substituted or unsubstituted C₁ to C₂₀ alkyl group, a substituted or unsubstituted C₂ to C₂₀ vinyl group, halogen, or a nitrile group.

### BRIEF DESCRIPTION OF DRAWINGS

Certain aspects, features, and advantages of the present disclosure are illustrated by the following detailed description with reference to the accompanying drawings.

FIG. 1 illustrates photos of flame retardancy evaluation of an example and a comparative example of the present disclosure.

### DETAILED DESCRIPTION

The present disclosure will be described in detail below. However, this is merely an example and the present disclosure is not limited to the specific embodiments described herein.

The present disclosure relates to an ionic liquid, an electrolyte for a secondary battery comprising the ionic liquid, and a secondary battery comprising the electrolyte.

The ionic liquid according to an embodiment of the present disclosure refers to a liquid salt comprising ions solely, and the ionic liquid according to the present disclosure may comprise a structure in which one or more cations are attached to a phosphate functional group.

More specifically, the ionic liquid may comprise a cationic compound represented by Chemical Formula 1 below.

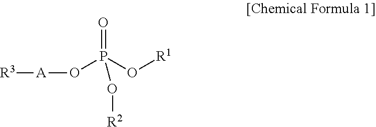

In Chemical Formula 1, R¹ and R² may independently be substituted or unsubstituted C₆ to C₂₀ aryl groups. Comprising the aryl groups represented by R¹ and R² in Chemical Formula 1, the ionic liquid may have improved reduction stability and superior electrochemical stability.

Specifically, R¹ and R² may independently comprise n substituents X or m substituents Y. X and Y may independently be a C₁ to C₆ alkyl group, a C₁ to C₆ alkoxy group, a halogen group, or a nitrile group. Furthermore, n and m may independently be integers greater than or equal to 1, for example, 1 to 5.

Furthermore, A may be, but is not limited to, a C₂ to C₂₀ alkenyl group.

R³ may be an N-containing heterocyclic cation. Specifically, R³ may be imidazolium, pyridinium, pyridazinium, pyrimidinium, pyrazinium, pyrrolidinium, pyrazolium, thiozolium, oxazolium, or triazolium. More specifically, R³ may be imidazolium and may be represented by Chemical Formula 2 below.

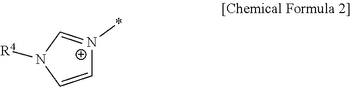

In Chemical Formula 2, R⁴ is a halogen, a substituted or unsubstituted C₁ to C₂₀ alkyl group, a substituted or unsubstituted C₁ to C₂₀ alkoxy group, a substituted or unsubstituted C₁ to C₂₀ vinyl group or a nitrile group. In Chemical Formula 2, * may represent a portion linked to A in Chemical Formula 1. In the present disclosure, the halogen may be F, Cl, Br, or I.

The cationic compound may be specifically represented by Chemical Formula 3.

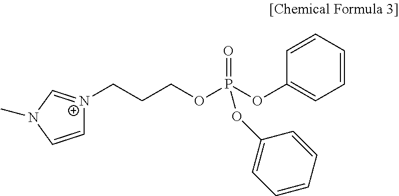 [SMILES: Cn1cc[n+](CCCOP(=O)(Oc2ccccc2)Oc2ccccc2)c1]

The cationic compound according to an embodiment of the present disclosure has a structure in which a cation is attached to a phosphate functional group, as described above. Flame retardancy may be improved by the phosphate functional group. Furthermore, while flame retardancy is improved, initial irreversible capacity may be reduced by reducing a reaction with graphite, a negative electrodeactive material.

The ionic liquid of the present disclosure may comprise an anionic compound along with the cationic compound. The ionic liquid may comprise the cationic compound and the anionic compound in a molar ratio such that the sum of charges thereof is zero. The anionic compound is not particularly limited, but may comprise, for example, trifluoromethylsulfonylimide (TFSI), bis(fluorosulfonyl)imide (FSI), chloride (Cl), dicyanamide (DCA), trifluoromethanesulfonate (Otf), acetate (Ac), hydroxide (OH), diethyl phosphate (DEP), thiocyanate (SCN), and methyl sulfate (MeSO₄). These anionic compounds may be used alone, or two or more thereof may be mixed to be used.

Specifically, the anionic compound may be trifluoromethylsulfonylimide, represented by Chemical Formula 4 below.

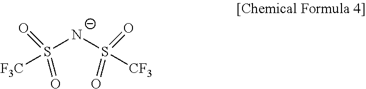 [SMILES: O=S(=O)([N-]S(=O)(=O)C(F)(F)F)C(F)(F)F]

The ionic liquid comprising the cationic compound and anionic compound according to the present disclosure has a low reduction potential, which reduces side reactions with a negative electrodeactive material, thereby reducing the initial irreversible capacity, and improves the flame retardancy of the electrolyte, thereby enhancing battery safety. More specifically, by comprising the cationic compound as described above, the ionic liquid, may form a robust CEI film and suppress side reactions, thereby improving flame retardant performance and battery performance. Furthermore, by comprising the anionic compound as described above, the ionic liquid may form a robust SEI film and suppress side reactions, thereby enhancing battery performance.

A specific ionic liquid according to an embodiment of the present disclosure may comprise, but is not limited to, the cationic compound of Chemical Formula 3 and the anionic compound of Chemical Formula 4.

The present disclosure also provides an electrolyte comprising the ionic liquid. The electrolyte may comprise a lithium salt, a solvent, and the ionic liquid.

The ionic liquid comprised in the electrolyte may be comprised in an amount of 1 wt % or more, specifically 1 to 10 wt %, based on the total weight of the electrolyte. If the content of the ionic liquid is less than 3 wt %, the flame retardancy improvement effect may be minimal, and if it exceeds 10 wt %, the flame retardancy improvement effect may be excellent, but the excessive content of the ionic liquid may cause a side reaction with the electrode, which may cause a decrease in capacity retention rate and an increase in resistance, thereby deteriorating the performance of the battery.

The lithium salt may be a lithium salt commonly used in a secondary battery without any specific limitation, and for example, the lithium salt may be expressed as Li+X⁻, and the anion (X⁻) of the lithium salt may comprise, for example, F⁻, Cl⁻, Br⁻, I⁻, NO₃, N(CN)₂⁻, BF₄⁻, ClO₄⁻, PF₆⁻, AsF₆⁻, SbF₆⁻, AlO₄⁻, AlCl₄⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CₓF₂ₓ₊₁SO₂)(C_{y}F_{2y+1}SO₂)N− (wherein x and y are integers greater than or equal to 0), CF₃CF₂ (CF₃)₂CO⁻, (CF₃SO₂)₂CH⁻, (SF₅)₃C⁻, (CF₃SO₂)₃C⁻, CF₃ (CF₂)₃SO₃⁻, CF₃ (CF₂)₇SO₃⁻, CF₃CO₂⁻, CH₃CO₂⁻, SCN⁻, B(C₂O₄)₂⁻, F₂BC₂O₄⁻, PF₄ (C₂O₄)⁻, PF₂ (C₂O₄)₂⁻, P(C₂O₄)₃⁻, or the like.

The organic solvent may be an organic compound having sufficient solubility in the lithium salt and additive and is non-reactive within the battery. Examples of such organic solvents comprise those commonly used in lithium secondary batteries. The organic solvents may comprise, for example, at least one of carbonate solvents, ester solvents, ether solvents, ketone solvents, alcohol solvents, and aprotic solvents.

The organic solvents may comprise, for example, propylene carbonate (PC), ethylene carbonate (EC), butylene carbonate, 2,3-butylene carbonate, diethyl carbonate (DEC), dimethyl carbonate (DMC), ethylmethyl carbonate (EMC), methylpropyl carbonate, ethylpropyl carbonate, dipropyl carbonate, dibutyl carbonate, methyl butyl carbonate, methyl isopropyl carbonate, fluoroethylene carbonate, vinylene carbonate, methyl ester, methyl formate, N,N-dimethylacetamide, methyl propionate (MP), ethylpropionate (EP), methylacetate (MA), ethylacetate (EA), n-propylacetate (n-PA), 1,1-dimethylethyl acetate (DMEA), fluoroethylacetate (FEA), difluoroethylacetate (DFEA), trifluoroethylacetate (TFEA), dimethyl ether, dibutyl ether, diethylene glycol dimethyl ether (DEGDME), triethylene glycol dimethyl ether, tetraethylene glycol dimethyl ether dimethyl ether (TEGDME), dimethoxymethane, dimethoxyethane, diethoxyethane, 1,2-dimethoxypropane, tetrahydrofuran (THF), 2-methyltetrahydrofuran, ethyl alcohol, isopropyl alcohol, 1,3-dioxolane, 4-methyl-1,3-dioxolane, dimethyl sulfoxide, acetonitrile, sulfolane, dimethyl sulfone, gamma-buturolactone, ethylene sulfite, propylene sulfite Examples of suitable solvents comprise sulfite, dimethyl sulfite, diethyl sulfite, and crown ether. These solvents may be used alone or in combination of two or more.

The electrolyte of the present disclosure may further comprise the phosphazene-based solvent. The phosphazene-based solvent may function as a radical scavenger. Therefore, the electrolyte comprising the phosphazene-based solvent may suppress chain reactions and improve flame retardancy by removing radicals generated as heat is generated within the battery. Furthermore, by forming a film on the electrode surface, side reactions between the electrolyte and the electrode may be suppressed.

As described above, due to the radical scavenging and electrode surface film formation of the phosphazene-based solvent, the thermal stability and flame retardancy of the secondary battery may be improved and cell performance may be maintained.

The phosphazene-based solvent is not particularly limited, but may be a compound represented by Chemical Formula 5 below.

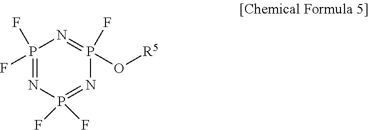

In Chemical Formula 5, R⁵ may be a substituted or unsubstituted C₁ to C₂₀ alkyl group, a substituted or unsubstituted C₂ to C₂₀ vinyl group, a halogen, or a nitrile group.

The phosphazene-based solvent may be comprised in an amount of 1 wt % or more based on the total weight of the electrolyte. Specifically, the phosphazene-based solvent may be comprised in an amount of 1 to 30 wt %. If the content of the phosphazene-based solvent is less than 1 wt %, the content of the phosphazene-based solvent may be low, so it is necessary to add a large amount of ionic liquid to reduce flame retardancy and initial irreversible capacity and the effect of forming a film on the electrode surface may be low, and if the content of the phosphazene-based solvent exceeds 30 wt %, the solubility of the electrolyte may decrease, which may cause a problem in that lithium salts and additives in the electrolyte are precipitated.

The electrolyte according to the present disclosure comprises an ionic liquid and a phosphazene-based solvent, thereby forming a robust SEI film on the surface of the negative electrode and a CEI film on the surface of the positive electrode. Specifically, the CEI film may be formed by comprising the cationic compound and the phosphazene-based solvent within the ionic liquid, and the SEI film may be formed by comprising the anionic compound within the ionic liquid. Accordingly, both battery thermal stability and high-temperature performance may be improved.

The electrolyte according to the present disclosure may comprise a negative electrode protective film-forming agent. The negative electrode protective film-forming agent added to the electrolyte may decompose during the initial charge/discharge process to form a protective film on the negative electrode, thereby suppressing electrolyte decomposition.

Generally, if the reduction stability of the ionic liquid is low, the ionic liquid may be significantly decomposed at the negative electrode. In particular, if the ionic liquid content exceeds 10%, excessive decomposition of the ionic liquid may occur, resulting in deterioration of cell performance. Therefore, the negative electrode protective film additive may be comprised to suppress the decomposition of the ionic liquid. By comprising the negative electrode protective film-forming agent, the decomposition of the ionic liquid may be partially suppressed, thereby further improving cell performance.

The negative electrode protective film-forming agent comprise, but are not limited to, for example, lithium bisoxalato borate (LiBOB), lithium difluoro(oxalato)borate (LiFOB), maleic anhydride, and lithium difluorobis-(oxalato)phosphate (W2), and any one thereof may be used alone, or two or more thereof may be used in combination. Specifically, the negative electrode protective film-forming agent may be LiBOB or LiFOB.

The negative electrode protective film-forming agent may be comprised in an amount of 0.2 to 2 wt % based on the total weight of the electrolyte. If the amount of the negative electrode protective film-forming agent is less than 0.2 wt %, the protective film may not be sufficiently formed, and thus, the effect of suppressing decomposition of the ionic liquid may not be sufficiently obtained, and if the amount exceeds 2 wt %, the remaining negative electrode protective film-forming agent after film formation may rather be decomposed, resulting in gas occurrence within the battery to deteriorate battery performance.

Furthermore, the present disclosure provides a secondary battery comprising the ionic liquid in the electrolyte. The secondary battery comprises a positive electrode, a negative electrode, and the electrolyte described above. Specifically, an electrode assembly comprising the positive electrode and the negative electrode and the electrolyte may be housed and sealed within a battery case, such as a pouch-type case, a prismatic case, a cylindrical case, or a coin-type case.

The electrode assembly may comprise at least one positive electrode and at least one negative electrode, which are laminated with a separator as a boundary or alternately laminated with the separator as a boundary. According to embodiments, the electrode assembly may be of a winding type, a stacking type, a z-folding type, or a stack-folding type.

The positive electrode may comprise a positive electrode current collector and a positive electrode mixture layer disposed on at least one surface of the positive electrode current collector.

The positive electrode current collector may comprise stainless steel, nickel, aluminum, titanium, or alloys thereof. The positive electrode current collector may also comprise aluminum surface-treated with carbon, nickel, titanium, or silver or stainless steel surface-treated with carbon, nickel, titanium, or silver. In addition, the positive electrode current collector may be a polymer substrate coated with a conductive metal, such as nickel, aluminum, titanium, or silver.

The positive electrode current collector may have various forms, comprising, but not limited to, foil, foam, net, porous material, or non-woven fabric. Furthermore, the positive electrode current collector may have a thickness of 10 to 50 μm, but is not limited thereto.

The positive electrode mixture layer may comprise a positive electrode active material. The positive electrode active material may comprise a compound capable of reversibly intercalating and deintercalating lithium ions.

For example, the positive electrode active material may comprise a lithium-nickel metal oxide. The lithium-nickel metal oxide may further comprise at least one of cobalt (Co), manganese (Mn), and aluminum (Al).

In some embodiments, the positive electrode active material or the lithium-nickel metal oxide may have a layered structure or crystal structure represented by Chemical Formula 9 below:

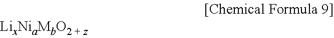

In Chemical Formula 9, 0.9≤x≤1.2, 0.6≤a≤0.99, 0.01≤b≤0.4, and −0.5≤z≤0.1. As described above, M may comprise Co, Mn, and/or Al.

The chemical structure represented by Chemical Formula 9 represents the bonding relationships within the layered structure or crystal structure of the positive electrode active material and does not exclude other additional elements. For example, M may comprise Co and/or Mn, and Co and/or Mn may serve as the main active element of the positive electrode active material together with Ni. Chemical formula 9 is provided to express the bonding relationship of the main active elements and should be understood as encompassing the introduction and substitution of additional elements.

In an embodiment, auxiliary elements may be further comprised in addition to the main active elements to enhance the chemical stability of the positive electrode active material or the layered/crystal structure. The auxiliary elements may be incorporated into the layered/crystal structure to form bonds, and in this case, they should also be understood as being comprised within the chemical structure represented by Chemical Formula 9.

The auxiliary elements may comprise, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, and Zr. The auxiliary element may also function as an auxiliary active element, such as Al, that contributes to the capacity/output activity of the positive electrode active material together with Co or Mn.

For example, the positive electrode active material or the lithium-nickel metal oxide may have a layered structure or crystal structure represented Chemical Formula 9-1:

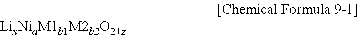

In Chemical Formula 9-1, M1 may comprise Co, Mn, and/or Al. M2 may comprise the auxiliary elements described above. In Chemical Formula 9-1, 0.9≤x≤1.2, 0.6≤a≤0.99, 0.01≤b1+b2≤0.4, and −0.5≤z≤0.1.

The positive electrode active material may further comprise a coating element or doping element. For example, elements substantially identical to or similar to the auxiliary elements described above may be used as the coating element or doping element. For example, the above-described elements, either alone or in combination, may be used as coating or doping elements.

The coating or doping elements may be present on the surface of the lithium-nickel metal oxide particles or may penetrate through the surface of the lithium-nickel metal composite oxide particles and be incorporated into the bonding structure represented by Chemical Formula 9 or Chemical Formula 9-1.

The positive electrode active material may comprise a nickel-cobalt-manganese (NCM)-based lithium oxide. In this case, an NCM-based lithium oxide with an increased nickel content may be used.

Ni may serve as a transition metal associated with the output and capacity of a lithium secondary battery. Therefore, by incorporating a high content (high-Ni) composition into the positive electrode active material as described above, a high-capacity positive electrode and a high-capacity lithium secondary battery may be provided.

However, as the Ni content increases, the long-term storage stability and lifespan stability of the positive electrode or secondary battery may be relatively reduced, and side reactions with the electrolyte may also increase. However, according to embodiments, the inclusion of Co may maintain electrical conductivity, while improving lifespan stability and capacity retention characteristics through Mn.

The Ni content (e.g., the mole fraction of nickel out of the total moles of nickel, cobalt, and manganese) in the NCM-based lithium oxide may be 0.6 or more, 0.7 or more, or 0.8 or more. In some embodiments, the Ni content may range from 0.8 to 0.95, 0.82 to 0.95, 0.83 to 0.95, 0.84 to 0.95, 0.85 to 0.95, or 0.88 to 0.95.

In some embodiments, the positive electrode active material may comprise a lithium cobalt oxide-based active material, a lithium manganese oxide-based active material, a lithium nickel oxide-based active material, or a lithium iron phosphate (LFP)-based active material (e.g., LiFePO₄).

In some embodiments, the positive electrode active material may comprise, for example, a Mn-rich-based active material, a Li-rich layered oxide (LLO)/over-lithiated oxide (OLO) active material, or a Co-less active material having a chemical structure or crystal structure represented by Chemical Formula 2.

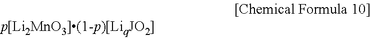

In Chemical Formula 10, 0<p<1, 0.9≤q≤1.2, and J may comprise at least one element selected from the group consisting of Mn, Ni, Co, Fe, Cr, V, Cu, Zn, Ti, Al, Mg, and B.

The positive electrode may be prepared, for example, by mixing the positive electrode active material in a solvent to prepare a positive electrode slurry, coating a positive electrode current collector with the positive electrode slurry, and then performing drying and rolling to form a positive electrode mixture layer.

The coating process may be performed using methods, such as gravure coating, slot die coating, multilayer simultaneous die coating, imprinting, doctor blade coating, dip coating, bar coating, and casting, but is not limited thereto.

The positive electrode mixture layer may further comprise a binder and, optionally, a conductive agent, a thickener, and the like.

Solvents used in the preparation of the positive electrode slurry comprise, but are not limited to, N-methyl-2-pyrrolidone (NMP), dimethylformamide, dimethylacetamide, N,N-dimethylaminopropylamine, ethylene oxide, and tetrahydrofuran.

The binder may comprise polyvinylidene fluoride (PVDF), vinylidene fluoride to Co-hexafluoropropylene copolymer, polyacrylonitrile, polymethylmethacrylate, acrylonitrile butadiene rubber (NBR), polybutadiene rubber (BR), styrene-butadiene rubber (SBR), etc. In an embodiment, a PVDF-based binder may be used as the positive electrode binder.

The conductive agent may be added to enhance the conductivity of the positive electrode mixture layer and/or mobility of lithium ions or electrons. For example, the conductive agent may comprise a carbon-based conductive agent, such as graphite, carbon black, acetylene black, Ketjen black, graphene, carbon nanotubes, vapor-grown carbon fiber (VGCF), carbon fiber, etc. and/or a metal-based conductive agent comprising perovskite materials, such as tin, tin oxide, titanium oxide, LaSrCoO₃, and LaSrMnO₃, but is not limited thereto.

Furthermore, the positive electrode mixture may further comprise a thickener and/or a dispersant, if necessary. In an embodiment, the positive electrode mixture may comprise a thickener, such as carboxymethyl cellulose (CMC).

The negative electrode may comprise a negative electrode current collector and a negative electrode mixture layer disposed on at least one surface of the negative electrode current collector.

The negative electrode current collector may comprise stainless steel, copper, nickel, titanium, or alloys thereof. The negative electrode current collector may also comprise copper surface-treated with carbon, nickel, titanium, or silver or stainless steel surface-treated with carbon, nickel, titanium, or silver. In addition, the negative electrode current collector may be a polymer substrate coated with a conductive metal, such as nickel, aluminum, titanium, or silver.

The negative electrode current collector may have various forms, comprising foil, foam, net, porous material, and non-woven fabric, as a non-limiting example. In addition, the negative electrode current collector may have a thickness of 10 to 50 μm, but is not limited thereto.

The negative electrode mixture layer may comprise a negative electrodeactive material. The negative electrode active material may be a material capable of adsorbing and desorbing lithium ions. For example, the negative electrode active material may comprise carbon-based materials, such as crystalline carbon, amorphous carbon, carbon composites, and carbon fibers; lithium metal; lithium alloys; silicon (Si)-containing materials, or tin (Sn)-containing materials.

Examples of the amorphous carbon may comprise hard carbon, soft carbon, coke, mesocarbon microbeads (MCMB), and mesophase pitch-based carbon fiber (MPCF).

Examples of the crystalline carbon may comprise graphitic carbons, such as natural graphite, artificial graphite, graphitized coke, graphitized MCMB, and graphitized MPCF.

The lithium metal may be pure lithium metal or lithium metal with a protective layer formed thereon to suppress dendrite growth, etc. In an embodiment, a lithium metal-containing layer deposited or coated on the negative electrode current collector may be used as a negative electrodeactive material layer. In another embodiment, a lithium thin film layer may also be used as the negative electrode active material layer.

Elements comprised in the lithium alloy may comprise aluminum, zinc, bismuth, cadmium, antimony, silicon, lead, tin, gallium, or indium.

The silicon-containing material may provide enhanced capacity characteristics. The silicon-containing material may comprise Si, SiOx (0<x<2), metal-doped SiOx (0<x<2), or a silicon-carbon composite. The metal may comprise lithium and/or magnesium, and the metal-doped SiOx (0<x<2) may comprise a metal silicate.

The negative electrode may be prepared, for example, by mixing the negative electrode active material in a solvent to prepare a negative electrodeslurry. The negative electrode mixture layer may further comprise a binder and, optionally, a conductive agent, a thickener, etc.

The negative electrode slurry may be coated/deposited onto the negative electrode current collector, followed by drying and rolling to produce the negative electrode mixture layer. The coating process may be performed using methods, such as gravure coating, slot die coating, multilayer simultaneous die coating, imprinting, doctor blade coating, dip coating, bar coating, and casting, but is not limited thereto.

In some embodiments, the negative electrode may comprise a negative electrodeactive material layer in the form of lithium metal formed through a deposition/coating process.

Non-limiting examples of solvents for the negative electrode mixture may comprise water, pure water, deionized water, distilled water, ethanol, isopropanol, methanol, acetone, n-propanol, t-butanol, and the like.

The binder may comprise polyvinylidene fluoride (PVDF), vinylidene fluoride to Co-hexafluoropropylene copolymer, polyacrylonitrile, polymethylmethacrylate, acrylonitrile butadiene rubber (NBR), polybutadiene rubber (BR), styrene-butadiene rubber (SBR), etc. In an embodiment, a styrene-butadiene rubber (SBR)-based binder, carboxymethyl cellulose (CMC), a polyacrylic acid-based binder, a poly(3,4-ethylenedioxythiophene, PEDOT)-based binder, etc. may be used as a negative electrode binder.

The binder may be comprised in an amount of about 1.5 to about 5 wt % based on the total weight of the negative electrode mixture layer.

The conductive agent may be added to enhance the conductivity of the negative electrode mixture layer and/or mobility of lithium ions or electrons. For example, the conductive agent may comprise, but is not limited to, carbon-based conductive agents, such as graphite, carbon black, acetylene black, Ketjen black, graphene, carbon nanotubes, vapor-grown carbon fiber (VGCF), and carbon fiber, and/or metal-based conductive agents, such as tin, tin oxide, titanium oxide, LaSrCoO₃, and LaSrMnO₃.

In an embodiment, the conductive agent may be comprised in an amount of about 0.05 to about 0.2 wt % based on the total weight of the negative electrode mixture layer.

If necessary, the negative electrode mixture layer may further comprise a thickener and/or a dispersant. In an embodiment, the negative electrode mixture layer may comprise a thickener, such as carboxymethyl cellulose (CMC).

The separator interposed between the positive electrode and the negative electrode may be configured to prevent electrical short-circuit between the positive electrode and the negative electrode and to cause ion flow. As an example, the thickness of the separator may be, but is not limited to, 10 μm to 20 μm.

For example, the separator may comprise a porous polymer film or a porous nonwoven fabric. The porous polymer film may comprise a polyolefin polymer, such as an ethylene polymer, a propylene polymer, an ethylene/butene copolymer, an ethylene/hexene copolymer, or an ethylene/methacrylate copolymer. The porous nonwoven fabric may comprise high-melting-point glass fibers, polyethylene terephthalate fibers, or the like. The separator may comprise a ceramic material. For example, inorganic particles may be coated on the polymer film or dispersed within the polymer film to improve heat resistance.

The separator may have a single-layer or multi-layer structure comprising the polymer film and/or non-woven fabric described above.

### EXAMPLES

Hereinafter, examples of the present disclosure will be further described with reference to specific experimental examples. The example and comparative example comprised in the experimental examples are merely illustrative of the present disclosure and do not limit the scope of the appended claims, and it will be apparent to those skilled in the art that various modifications and variations of the examples may be made within the scope and technical spirit of the present disclosure, and such modifications and variations are also within the scope of the appended claims.

### Example 1

An electrolyte was prepared by introducing 1M of LiPF₆ and additives comprising 1 wt % of fluoro-ethylene carbonate (FEC), 0.5 wt % of 1-propene 1,3-sultone (PRS), 1 wt % of LiPO₂F₂, 0.5 wt % of 1,3-propane sultone (PS), 0.5 wt % of ethylene sulfate (ESA), 5 wt % of an ionic liquid comprising the cation compound of Chemical Formula 6 and the anion compound of Chemical Formula 7, and 5 wt % of the phosphazene compound of Chemical Formula 8 into the remaining mixed solvent.

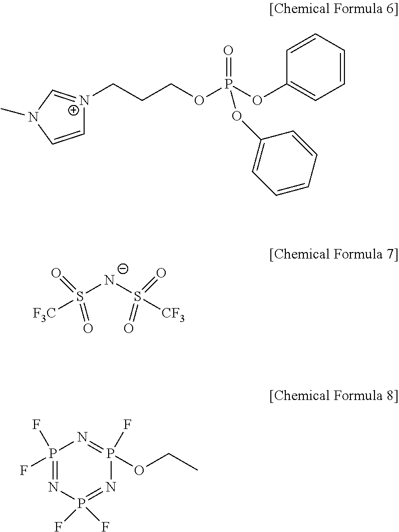 [SMILES: Cn1cc[n+](CCCOP(=O)(Oc2ccccc2)Oc2ccccc2)c1 ; O=S(=O)([N-]S(=O)(=O)C(F)(F)F)C(F)(F)F ; CCOP1(F)=NP(F)(F)=NP(F)(F)=N1]

The mixed solvent was prepared by mixing ethylene carbonate (EC), ethyl methyl carbonate (EMC), and diethyl carbonate (DEC) in a volume ratio of 25:45:30.

### Comparative Example 1

An electrolyte was prepared by introducing 1M of LiPF₆ and additives comprising 1 wt % of fluoro-ethylene carbonate (FEC), 0.5 wt % of 1-propene 1,3-sultone (PRS), 1 wt % of LiPO₂F₂, 0.5 wt % of 1,3-propane sultone (PS), and 0.5 wt % of ethylene sulfate (ESA) into the remaining mixed solvent.

The mixed solvent was prepared by mixing ethylene carbonate (EC), ethyl methyl carbonate (EMC), and diethyl carbonate (DEC) in a volume ratio of 25:45:30.

### Evaluation of Flame Retardant Characteristics

### Self-Extinguishing Time and Delay Time

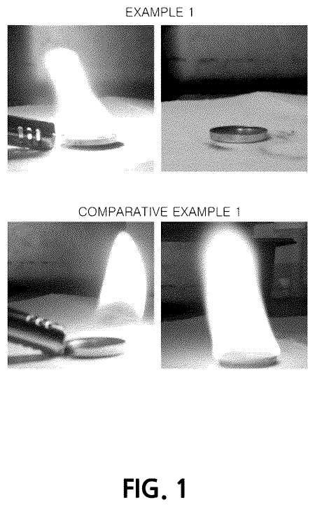

FIG. 1 illustrates photographs of evaluation of the flame retardant characteristics of Example 1 and Comparative Example 1. As shown in FIG. 1, the electrolytes of Example 1 and Comparative Example 1 were ignited using a tool, the time from the removal of the tool until the flame was extinguished was measured, and the self-extinguishing time was evaluated based thereon, which is shown in Table 1. The self-extinguishing time is the unit time (in seconds) required for extinguishment per weight of electrolyte.

Secondary batteries comprising the electrolytes of Example 1 and Comparative Example 1 were manufactured, the temperature of the secondary batteries was increased to 150° C., and the time required for the secondary batteries to explode was measured as the delay time, the results of which are provided in Table 1.

TABLE 1

| | | Comparative |
|---|---|---|
| Analysis of flame retardancy | Example 1 | Example 1 |
| Self-extinguishing time (sec.) | 0 | 98 |
| Delay time (min.) | (+10.5) | — |

As can be seen from Table 1, the electrolyte of Comparative Example 1 took 98 seconds to extinguish, while the electrolyte of Example 1 was evaluated to be extinguished immediately after the tool was removed, as shown in FIG. 1. Therefore, it can be seen that the electrolyte of Example 1 demonstrated a significantly shorter self-extinguishing time. Furthermore, it can be seen that the explosion time was delayed compared to Comparative Example 1 at a high temperature of 150° C. Therefore, the flame retardancy of the electrolyte may be significantly improved, thereby enhancing the safety of the secondary battery. Therefore, flame retardancy may be significantly improved by comprising the ionic liquid comprising the cationic compound represented by Chemical Formula 1 in the electrolyte, and further by comprising the phosphazene compound.

### Evaluation of Battery Performance

Secondary battery cells were manufactured using the electrolytes of Example 1 and Comparative Example 1. Capacity and DCIR were measured as the initial performance of the manufactured secondary batteries, and the results are provided in Table 2.

Thereafter, the secondary batteries were left at 60° C. for one week and subjected to a high-temperature storage test. The DCIR and capacity retention rates of the batteries were evaluated, and the results are provided in Table 2.

Furthermore, the secondary batteries were subjected to 100 charge-discharge cycles at 45° C., and the capacity, capacity retention rate, and DCIR were evaluated. The results are also shown in Table 2.

TABLE 2

| | | | Comparative |
|---|---|---|---|
| | | Example 1 | Example 1 |
| Initial | Capacity (mAh) | 1846.3 | 1855 |
| performance | DCIR (mΩ) | 37.1 | 34.4 |
| High-temperature | Capacity | 93.3 | 94.5 |
| storage | retention rate | | |
| performance | (%) | | |
| (60° C., first | DCIR (mΩ) | 33.1 | 29.3 |
| week) | | | |
| High-temperature | Capacity (mAh) | 1676 | 1788 |
| lifespan | Capacity | 93.5 | 96.6 |
| (45° C., 100 | retention rate | | |
| cycles) | (%) | | |
| | DCIR (mΩ) | 28.08 | 24.63 |

As can be seen from Table 2, the secondary battery comprising the electrolyte of Example 1 exhibited decreased characteristics in terms of capacity, capacity retention, and DCIR due to the inclusion of the ionic liquid comprising the cationic compound of Chemical Formula 1 in the electrolyte. However, the degree of decrease was minimal, indicating that the battery performance was maintained. The evaluation results of battery performance and flame retardancy characteristics indicate that the inclusion of the electrolyte provided by the present disclosure significantly improves flame retardancy while maintaining battery performance.

According to an embodiment of the present disclosure, the flame retardancy of the electrolyte for a secondary battery may be improved, thereby enhancing the safety of the secondary battery.

According to another embodiment of the present disclosure, a robust SEI or CEI film may be formed on the surfaces of the negative and positive electrodes, thereby improving the thermal stability and high-temperature performance of the secondary battery.

The ionic liquid of the present disclosure and the electrolyte comprising the ionic liquid may be widely applied in green technology fields, such as electric vehicles, battery charging stations, and other solar and wind power generation using batteries. Furthermore, the ionic liquid of the present disclosure and the electrolyte comprising the ionic liquid may be used in eco-friendly electric vehicles, hybrid vehicles, and other vehicles to prevent climate change by suppressing air pollution and greenhouse gas emissions.

Only specific examples of implementations of certain embodiments are described. Variations, improvements and enhancements of the disclosed embodiments and other embodiments may be made based on the disclosure of this patent document.

What is claimed is:

1. An ionic liquid comprising a cationic compound represented by Chemical Formula 1: 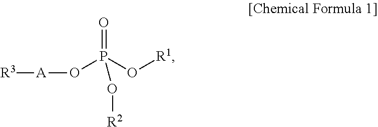
wherein R¹ and R² are independently substituted or unsubstituted C₆ to C₂₀ aryl groups, R³ is an N-containing heterocyclic cation, and A is a C₂ to C₂₀ alkenyl group.

2. The ionic liquid of claim 1, wherein the R¹ and R² independently comprise n substituents X or m substituents Y, X and Y are independently a C₁ to C₆ alkyl group, a C₁ to C₆ alkoxy group, a halogen group, or a nitrile group, and n and m are independently integers greater than or equal to 1.

3. The ionic liquid of claim 1, wherein the R³ is imidazolium, pyridinium, pyridazinium, pyrimidinium, pyrazinium, pyrrolidinium, pyrazolium, thiazolium, oxazolium or triazolium.

4. The ionic liquid of claim 1, wherein the R³ is represented by Chemical Formula 2: 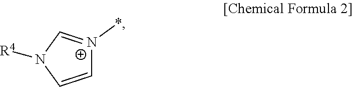
wherein R⁴ is a halogen, a substituted or unsubstituted C₁ to C₂₀ alkyl group, a substituted or unsubstituted C₁ to C₂₀ alkoxy group, a substituted or unsubstituted C₁ to C₂₀ vinyl group, or a nitrile group.

5. The ionic liquid of claim 1, wherein the cationic compound is represented by Chemical Formula 3:

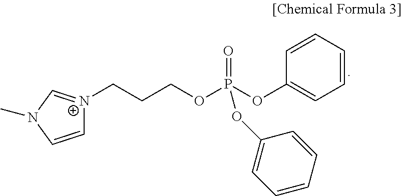 [SMILES: Cn1cc[n+](CCCOP(=O)(Oc2ccccc2)Oc2ccccc2)c1]

6. The ionic liquid of claim 1, further comprising at least one anionic compound selected from the group consisting of trifluoromethylsulfonylimide (TFSI), bis(fluorosulfonyl)imide (FSI), trifluoromethanesulfonate (OTf), chloride (Cl), dicyanamide (DCA), acetate (Ac), hydroxide, diethylphosphate (DEP), thiocyanate (SCN), and methylsulfate (MeSO₄).

7. The ionic liquid of claim 1, further comprising an anionic compound represented by Chemical Formula 4:

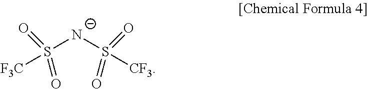 [SMILES: O=S(=O)([N-]S(=O)(=O)C(F)(F)F)C(F)(F)F]

8. An electrolyte comprising the ionic liquid of claim 1.

9. The electrolyte of claim 8, further comprising a phosphazene compound.

10. The electrolyte of claim 9, wherein the phosphazene compound is represented by Chemical Formula 5: 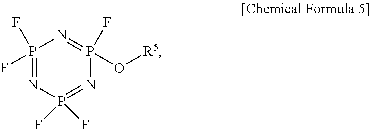
wherein R⁵ is a substituted or unsubstituted C₁ to C₂₀ alkyl group, a substituted or unsubstituted C₂ to C₂₀ vinyl group, halogen, or a nitrile group.

11. A secondary battery comprising:
a positive electrode, a negative electrode, and an electrolyte,
wherein the electrolyte comprises the ionic liquid of claim 1.

12. The secondary battery of claim 11, wherein the electrolyte further comprises a phosphazene compound.

13. The secondary battery of claim 12, wherein the phosphazene compound is represented by Chemical Formula 5: 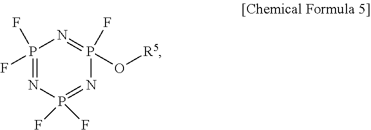
wherein R⁵ is a substituted or unsubstituted C₁ to C₂₀ alkyl group, a substituted or unsubstituted C₂ to C₂₀ vinyl group, halogen, or a nitrile group.
